(19) United States
(12) Patent Application Publication
(10) Pub. No.: US 2005/0116829 A1
(43) Pub. Date: Jun. 2, 2005

(54) Method for ascertaining a critical driving behavior

(76) Inventors: Winfried Koenig, Pfinztal (DE); Arnd Engeln, Tuebingen (DE); Lars Placke, Hannover (DE); Ulrich Ladstaetter, Weinstadt (DE)

Correspondence Address: KENYON & KENYON, ONE BROADWAY, NEW YORK, NY, 10004, US

(21) Appl. No.: 10/911,077

(22) Filed: Aug. 4, 2004

(30) Foreign Application Priority Data
Aug. 5, 2003 (DE) 103 35 741.6

(51) Int. Cl. G08B 23/00

(52) U.S. Cl. 340/576

(57) ABSTRACT

A method for ascertaining a critical driver behavior, in which an operative control undertaken by the driver is evaluated and compared to a stored user profile in such a way that, given a deviation of the operative control from the stored user profile, a critical driver behavior is ascertained.

### BACKGROUND INFORMATION

The present invention relates to a method for ascertaining a critical driving behavior. A method for warning a driver of a vehicle is described in German Patent Application No. DE 100 39 795 A1. In that case, the output of warnings is controlled as a function of the driver's attentiveness. This prevents warnings of critical situations from being output to a driver when he/she has already perceived a danger. It is also proposed to ascertain the attentiveness of the driver as low when a predefined value of an operative-control frequency of a device is exceeded.

### SUMMARY

A method according to an example embodiment of the present invention may have the advantage that not only a comparison to a predefined value is carried out for ascertaining a critical driving behavior, but also a comparison to a user profile of a driver. To be understood by operative-control behavior of the driver is the frequency of individual operative-control actions, their dynamics and their effect, i.e., the changes resulting from the adjustments in the vehicle. In particular, operative controls of vehicle components are evaluated for which a change has a direct effect on the driver himself, e.g., an air-conditioning function, a seat adjustment or a selection on the radio. For example, a desired, excessively high temperature in the vehicle, or also the opening of a window when the inside temperature is relatively pleasant may be conspicuous. By comparing the operative-control behavior to, for example, a driver-specific user profile, it is possible to determine a critical driving behavior of a user more precisely than merely by a comparison to a predefined value. In addition, the user profile may include a plurality of characteristic quantities, so that it becomes possible to not merely already ascertain a critical driving behavior in response to the deviation of a single characteristic quantity, but rather to consider various deviations in combined fashion for determining a critical driving behavior. The accuracy with which a critical driving behavior can be determined is also thereby increased. On one hand, it is therefore ensured that a driver is warned of actually critical driving situations when he/she exhibits a critical driving behavior. On the other hand, unnecessary warnings are avoided, so that the acceptance of the system by a user is increased.

According to an embodiment of the present invention, it may be particularly advantageous to evaluate an operative-control frequency, an operative-control selection and/or operative-control dynamics of an operative control by a user for determining a critical driving behavior, and to compare them to a stored user profile. The reason is that an increased operative-control frequency of vehicle systems or vehicle functions, particularly comfort functions such as the seat adjustment, the air-conditioning control or opening of the window or sunroof indicates that a driver feels ill at ease in the vehicle and is attempting to produce the most comfortable possible situation again in the vehicle.

An unusual operative-control selection, such as the window open, the air conditioner especially cold and/or the car radio particularly loud, which deviates from the usual settings by a driver can give an indication that the driver is becoming tired, for example, and wants to combat his/her fatigue using these adjustments. The driving behavior is possibly to be evaluated as critical in this case, as well.

Increased operative-control dynamics, to be understood by operative-control dynamics being a measure for the force with which a manually actuatable operating element is actuated, may infer increased aggressiveness of the driver. A particularly aggressive driver may not be inclined to observe safety distances or speed limits. The driving behavior is to be evaluated as critical in this case, as well.

If a critical driving behavior has been determined, this can be relayed to various vehicle systems. The relay to warning systems, which can accordingly lower the warning thresholds at which driver warnings are output, is particularly advantageous.

In the event of a repeated deviation from a stored driver behavior, it is also advantageous to correct the user profile so that a precise determination of a critical driving behavior is retained and warnings are not output unnecessarily.

It is further advantageous that a motor vehicle is already equipped with a plurality of operator's controls. Information resulting from the selection of the settings or from a frequency of the setting changes or the operative-control dynamics may be ascertained without further costly components having to be installed in the vehicle for that purpose.

### BRIEF DESCRIPTION OF THE DRAWINGS

Exemplary embodiments of the present invention are shown in the figures and are explained in detail below.

FIG. 1 shows an example device of the present invention for carrying out the method of the present invention for ascertaining a critical driving behavior;

FIG. 2 shows an example method sequence of the present invention for ascertaining a critical driving behavior.

### DETAILED DESCRIPTION OF EXAMPLE EMBODIMENTS

The method of the present invention may be used in any vehicles. The use in motor vehicles is particularly advantageous, since they are possibly used by several users, so that in each case a personal assignment of a user profile to one driver permits optimal adaptation of the detection of a critical driving behavior to the specific driver. In addition, in contrast to, for example, airplanes or rail vehicles, motor vehicles are not subject to central monitoring, so that critical driving behavior will possibly remain undiscovered, thereby increasing the risk for the driver and other road users. In the following, the method of the present invention is explained using a practical application in a motor vehicle as an example.

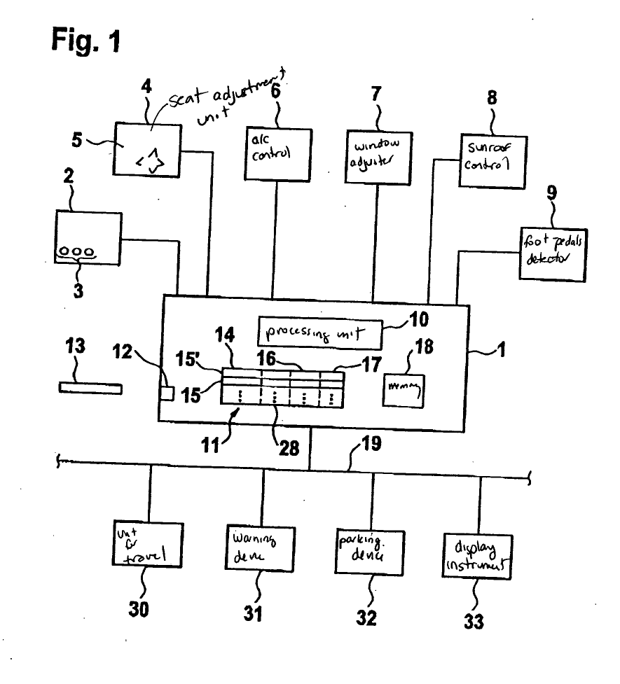

FIG. 1 shows a central data acquisition unit 1 used for determining the driver behavior. Data acquisition unit 1 is connected to the controls of various vehicle systems. An operative control of a vehicle system or a selection of a vehicle function is communicated to data acquisition unit 1. A car radio 2, inter alia, is connected to data acquisition unit 1 for this purpose. Car radio 2 has push buttons and/or rotary controls 3 used for selecting a radio program and controlling the volume of car radio 2. A seat-adjustment unit 4 is also connected to data acquisition unit 1, a seat adjustment being implemented via a rocker switch 5. Moreover, an air-conditioning control 6, a window adjuster 7, a sunroof control 8 and a foot-pedals detector 9 are connected to data acquisition unit 1. The accelerator pedal, the clutch pedal and/or the brake pedal is/are included in foot-pedals detector 9. Fewer, but also even further operating units in the vehicle may be connected to data acquisition unit 1.

At least one of the following variables is acquired from the operating units: frequency of an actuation of an operating element per unit of time, type of function selected, force used during the actuation. Instead of a discrete connection for each of the vehicle components or vehicle operative-control components, they may also be connected to data acquisition unit 1 via a bus system.

Data acquisition unit 1 has a processing unit 10 which processes the input data. Processing unit 10 compares the data concerning the operative control of the operating units, and therefore the operative-control behavior of the driver, to a user profile stored in a memory 11. The user profile is stored in non-volatile manner in memory 11. It may be supplied to memory 11 via a data interface. Thus, for example, it is possible to provide an insertion opening 12 for a data medium card 13, e.g., a card having an applied memory chip, on data acquisition unit 1 or at another suitable location in the vehicle with data contact to data acquisition unit 1.

Data acquisition unit 1 may be implemented as a hardware component which optionally even has its own housing. However, it is also possible to implement data acquisition unit 1 as a software component which has suitable software interfaces to the indicated remaining systems.

The individual vehicle functions concerning which the user profile has information are stored in memory 11 in a first column 14. Stored values with respect to the plurality of user functions are in further lines 15, 15′. A value for the frequency with which a vehicle function is operated is stored in a second column 28. Preferred selection and parameters for the vehicle function are stored in a third column 16. A typical force for the operative control of an allocated operating element is stored in a fourth column 17. If processing unit 10 determines deviations between the measured values of the vehicle operative control and the user profile stored in memory 11, this deviation is stored in a deviation memory 18. If the deviation occurs more frequently, the user profile is corrected accordingly in the deviating entry in the direction of the deviation. Deviation memory 18 is preferably also implemented as a nonvolatile memory, so that the deviations are available even after the vehicle is switched off. The deviations are only erased when either a certain period of time has elapsed since their entry, or the value stored in memory 11 was corrected in the appropriate direction which the deviation specifies. In one preferred embodiment, it is possible to create a separate user profile of the operative-control behavior for each driver, which is selected after a suitable identification of a user and is processed by processing unit 10.

In one special specific embodiment, it is possible that only deviations from standard values predefined in a further memory unit (not shown) have to be stored in the user profile of the operative-control behavior. This makes it possible to save on memory space. A reduction in memory space is possible in particular for the case when a driver does not use various functions. Given storage on a memory card, which can also be transferred to other vehicles having a device according to the present invention, a vehicle-specific adaptation may therefore be implemented. Thus, when driving, a higher volume adjustment of a radio can be assumed in a vehicle with greater wind noise than in a vehicle in whose passenger compartment it is generally quiet.

Therefore, when the user profile is transferred to another vehicle, it may be adapted immediately to the other vehicle.

The force during an operative control, e.g., during an activation of the vehicle horn or when operating the radio, is advantageously measured by operator's controls which have sensor systems sensitive either to acceleration or to force. For example, one design is possible using resistive sensors or sensors based on piezo technology for registering acting forces. The sensors are situated on the operator's controls or inserted into them and ascertain the force acting on the operator's control during an actuation by a user. The information about the force exerted during the operative control is passed on to data acquisition unit 1.

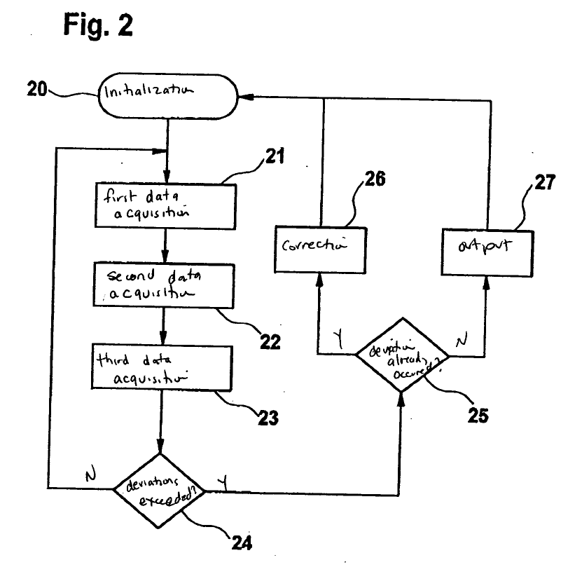

A processing procedure according to the present invention for determining a critical driver behavior is shown in FIG. 2. Starting from an initialization step 20, the driver behavior begins to be monitored. In one preferred embodiment, monitoring of the driver behavior begins only approximately five minutes after the vehicle has been started, i.e., only when the coolant has reached operating temperature. This prevents adaptations of the vehicle functions at the beginning of a trip to the current driving situation from invalidating an assessment of the driver behavior. For example, in winter, an extreme direction of the ventilation toward a windshield at maximum heating output is selected for defrosting the windshield. However, no conclusion concerning the driver behavior can be inferred from such an adjustment. The same holds true, for instance, for a vehicle which was switched off in the sun and which initially should be cooled down by a suitable setting of the air conditioning.

Following initialization step 20 is a first data acquisition step 21. In first data acquisition step 21, a query as to the number of operative controls carried out since the last acquisition is conducted at those vehicle components which provide this data. In a second subsequent data acquisition step 22, in the same way an operative-control selection is queried, i.e., which function was selected in this period of time. In a subsequent third data acquisition step 23, there is a query as to how great the operative-control force was for a specific individual operative control carried out since the last query. The variables—operative-control frequency, setting inputs and operative-control dynamics—thus obtained are each compared to the values stored in columns 28, 16, 17. To this end, it may also be necessary to determine the operative-control frequency from the number of operative controls in relation to the data acquisition time.

For a car radio, for example, as operative-control frequency, an operative control of one user interaction per minute may be predefined as a limiting value. A specific volume-level range and/or a specific radio tuning may be predefined as the function selection. The force of 100 newtons may be predefined, for example, as a limiting value for a force on an operating element. For a climate-control device, for example, one actuation in three minutes, a temperature selection of 22° and an operative-control force of 80 newtons may be provided. These values are either set by a user or are initially predefined at the factory, but are adapted to the desires of a user during utilization.

Furthermore, a typical value may be predefined for a cruise control within the framework of a distance-control device, for instance; in this case, no operative-control pressure and no operative-control frequency are acquired at the same time. It is also possible, for example, upon actuation of the sunroof, to record merely the operative-control frequency, while when a power-window unit is actuated, both the operative-control frequency and the operative-control selection, e.g., half open or completely open window, are also recorded. With respect to the foot pedals, both the operative-control frequency and the operative-control dynamics are advantageously recorded. In this context, the accelerator and the brake are monitored in particular.

In a first check step 24 following third data acquisition step 23, the deviations—i.e., the exceeding of limit values of the ascertained user data—from the stored user profile are determined. Preferably, a single deviation in a stored operative-control behavior is not yet sufficient for the data acquisition unit to determine a critical driving behavior. At least three different deviations in one data acquisition period are preferably necessary for this purpose. Optionally, certain correlation instructions, where a certain combination of deviations must be fulfilled, may be predefined for data acquisition unit 1. For example, an open window together at the same time with a loudly adjusted radio will lead to the determination of a critical driving behavior, namely, to the determination that a driver is tired. If no such deviation is established in first check step 24, then the data acquisition steps are repeated after a predefined period of time, e.g., after one minute. If, however, it is established in first check step 24 that a sufficient number of deviations exist, then the procedure branches to a second check step 25. In second check step 25, it is checked whether this deviation has already occurred in the past. To this end, the ascertained deviations are compared to the deviations stored in deviation memory 18. If the deviation has already occurred several times, e.g. already during a previous trip or for a longer period of time, e.g. an hour, then the procedure branches to a correction step 26 in which the stored user profile is corrected by an average using the recorded deviations. However, if it is detected in second check step 25 that until now, such deviations have occurred only seldom or not at all, then the procedure branches to an output step 27 in which the deviation is written into deviation memory 18. In addition, data acquisition unit 1 outputs a corresponding information signal to a data bus 19, to which in turn a plurality of vehicle components is connected. In a first specific embodiment, the data acquisition unit only outputs that a critical driving behavior exists. In a further specific embodiment, however, suitable evaluation data may also be made available to processing unit 10, based on which processing unit 10 is able to ascertain which critical driving behavior is possibly involved. For instance, given frequent actuation of the foot pedals, this could be aggressive driving. Given frequent operative control of the radio together with an open window or a climate control system set to be particularly cold, it could, for example, be driver fatigue.

In the exemplary embodiment shown here, a unit 30 for travel following a preceding vehicle at a regulated distance, a device 31 warning that the vehicle is leaving its lane, a parking device 32 and a display instrument 33 for receiving the indications of a critical driving behavior are connected to data bus 19. The device for following a preceding vehicle at a regulated distance selects a larger distance value which is maintained to a preceding vehicle when a critical driver behavior is ascertained. Device 31 for warning that the vehicle is leaving its lane already outputs warnings earlier, thus already upon approaching lateral roadway boundaries or in response to a slight exceeding of the lateral roadway boundaries. Parking device 32 already outputs warnings at greater distance values to obstacles. In one preferred specific embodiment, a corresponding warning field which indicates a critical warning behavior to the driver, e.g., by the representation of a warning triangle, is lighted from behind in display instrument 33. With a suitable display, the driver also receives an indication that his/her driving behavior is possibly critical and he/she should possibly have a pause.

1-8. (canceled)

9. A method for ascertaining a critical driver behavior, comprising:
evaluating an operative-control behavior of a driver;
comparing the operator-control behavior to a stored user profile; and
ascertaining a critical driver behavior if the operative-control behavior deviates from the stored user profile.

10. The method as recited in claim 9, wherein the evaluating step includes evaluating, for determining the operative-control behavior, at least one of an operative-control frequency, an operative-control selection, and an operative-control dynamics.

11. The method as recited in claim 9, wherein repeated deviations from the user profile are evaluated for correction of the user profile.

12. The method as recited in claim 9, wherein a critical driver behavior is relayed to at least one warning system in the vehicle for lowering warning thresholds.

13. The method as recited in claim 9, wherein the operative control includes at least one of a radio operative control, an air conditioner control, a window control, and a seat control.

14. A device for ascertaining a critical driver, behavior, comprising:
a central data acquisition unit configured to acquire a plurality of operator actions;
a memory to store a user profile;
a processing unit configured to compare the operator actions to the user profile; and
an interface configured to output a critical driver behavior to vehicle systems.

15. The device as recited in claim 14, wherein forces acting on operating elements during the plurality of operator actions are communicated to the central data acquisition unit.

16. An operating unit for connection to a central data acquisition unit for recording a plurality of operator actions, comprising:
a device for measuring a force exerted on an operating element during an operator action, the device configured to transmit the measure of the force to the data acquisition unit which determines a critical driver behavior as a function of the measured force and a stored user profile.
